(19) United States
(12) Patent Application Publication
(10) Pub. No.: US 2009/0097278 A1
(43) Pub. Date: Apr. 16, 2009

(54) Light Indicator

(76) Inventors: FENG-JUNG HSU, Sansia Township (TW); Chia-Jung Chen, Hsinchu City (TW)

Correspondence Address: HDLS Patent & Trademark Services, P.O. BOX 220746, CHANTILLY, VA, 20153-0746, US

(21) Appl. No.: 11/959,273

(22) Filed: Dec. 18, 2007

(30) Foreign Application Priority Data
Oct. 11, 2007 (TW) 096138005

(51) Int. Cl. F21V 8/00

(52) U.S. Cl. 362/632

(57) ABSTRACT

A light indicator includes a reflector element, a transparent element, and an emitting element. The transparent element includes a light incident surface and a light emitting surface. The emitting element is arranged symmetrically on two sides of the transparent element so that light beams emitted from the emitting element can enter into the transparent element though the light incident surface and the light emitting surface can emit uniform light beams. The reflector element surrounds the transparent element and the emitting element to ensure that part of light beams can enter into the transparent element through the light incident surface after being reflected one or more times. The light indicator of the invention has a uniform light distribution and a high utilization rate of light.

### 1. FIELD OF THE INVENTION

The invention relates to a light indicator, especially relates to a light indicator which can display with uniform light beams.

### 2. DESCRIPTION OF THE RELATED ART

Light indicator is commonly used in an electronic device for indicating the status of the electronic device so the user of the electronic device can control and adjust the status of the electronic device. Because light indicators are not used for illumination, light indicators are commonly consisted of a transparent element such a Polyvinylchloride (PVC) element or a polymethyl methacrylate (PMMA) element and an indicator light such as a LED or a tiny bulb. The design of a light indicator not only can save the amount of emitting elements, but also can guide the direction of the light and provide different display shapes.

FIG. 1 is a platform of a conventional light indicator. The light indicator 1 includes a light guide plate 10 and two light emitting diodes (LEDs) 12. The light guide plate include a first light incident surface 102, a second light incident surface 104 opposite to the first light incident surface 102, and a light emitting surface 106 perpendicular to the first light incident surface 102 and the second light incident surface 104. The two LEDs 12 are provided respectively close to the position of the first light incident surface 102 and the second light incident surface 104.

The light from the LEDs 12 emits to the light guide plate 10 respectively through the first light incident surface 102 and the second light incident surface 104, and then emits out from the light emitting surface 106 after being passed and scattered in the light guide plate. Thus, the light indicator is lighted.

However, the positions of the LEDs 12 and the directly incidence of the light to the light guide plate 10 cause the luminance of the light emitting surface 106 being not uniform, especially the luminance of the area close to the first light incident surface 102 and the second light incident surface 104 is apparently higher than other areas. In addition, the light from the LEDs 12 is not a single direction light and can't completely enter into the light guide plate 10, thus light leakage is caused. The utilization rate of light is reduced.

What is needed is a light indicator which has a uniform light distribution and a high utilization rate of light.

### BRIEF SUMMARY

One object of the invention is to provide a light indicator which has a uniform light distribution and a high utilization rate of light.

According to an embodiment of the invention, the light indicator includes a transparent element, an emitting element and a reflector element. The reflector element surrounds emitting element and the transparent element. One part of light beams emitted from emitting elements can directly enter into the transparent element and another part of light beams also can enter into the transparent element 10 after being reflected one or more times by the reflector element. Thus, the transparent element can display with uniform light beams and the light indicator has a good indicating effect.

According to preferred embodiment of the invention, the transparent is mixed into a light-scattering impurity to enhance the light scattering effect. Thus, the transparent element can display with uniform light beams and the light indicator has a good indicating effect.

Because the reflector element surrounds emitting element and the transparent element, one part of light beams emitted from emitting elements can directly enter into the transparent element and another part of light beams also can enter into the transparent element 10 after being reflected one or more times by the reflector element. Therefore, light leakage and light waste can be avoided and the light indicator has a good light utilization rate.

### BRIEF DESCRIPTION OF THE DRAWINGS

These and other features and advantages of the various embodiments disclosed herein will be better understood with respect to the following description and drawings, in which like numbers refer to like parts throughout.

FIG. 1 is a platform diagram of a light indicator of a prior art.

FIG. 2 is a schematic diagram of a light indicator according to an embodiment of the invention.

FIG. 3 is a schematic diagram of a light indicator according to another embodiment of the invention.

FIG. 4 is a schematic diagram showing an application of a light indicator of the invention.

FIG. 5 is a schematic diagram showing another application of a light indicator of the invention.

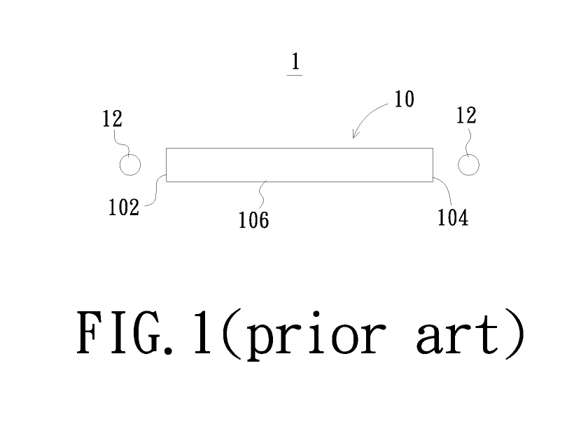

### DETAILED DESCRIPTION

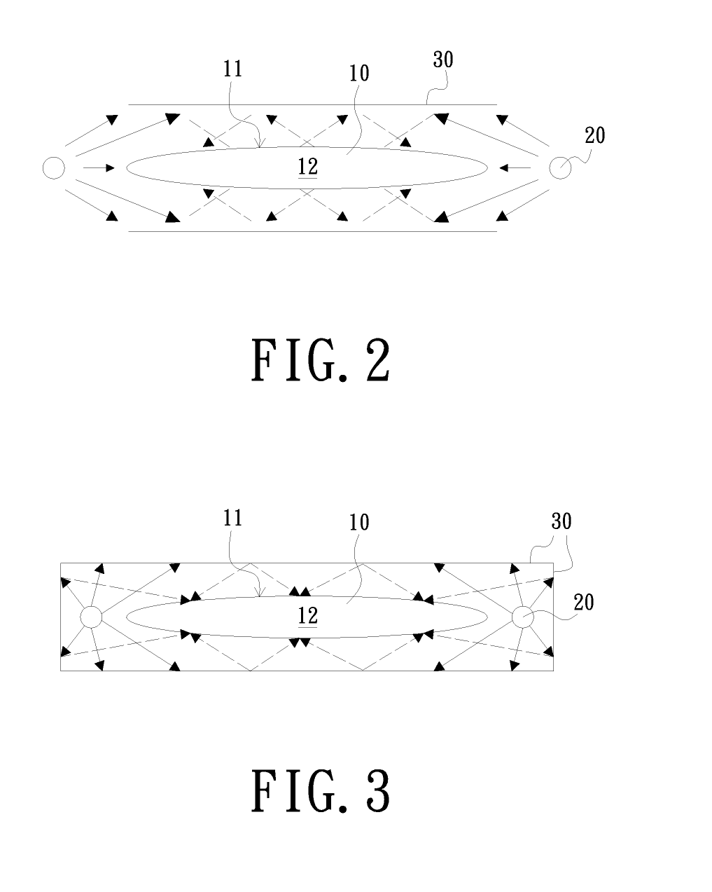

FIG. 2 is a schematic diagram showing the structure of a light indicator according to the first embodiment of the invention. The light indicator includes a transparent element 10, an emitting element 20 and a reflector element 30.

The transparent element 10 is transparent and can be made of polymethyl methacrylate (PMMA), Polyvinylchloride (PVC) and polycarbonate (PC). The transparent element 10 includes a light incident surface 11 and a light emitting surface 12 for light emitting out. As shown in FIG. 2, the light emitting direction is perpendicular to the paper of FIG. 2. The light incident surface 11 is one of the surfaces besides the light emitting surface 12. The light incident surface 11 is a frosting surface formed by frosting etching or rubbing. That is, the light incident surface is rough to reduce the rate of light reflection so that more light beams can enter into the transparent element 10.

The emitting element 20 is utilized for generating light beams. The light beams from the emitting element 20 are preferred in a single direction. So a light emitting diode (LED) is preferred but not limited to be an emitting element 20. The emitting element 20 also can be a bulb or a cold cathode fluorescent lamp (CCFL). The light indicator is preferred to have two emitting elements 20 which are symmetrically arranged on two sides of the transparent element 10 and not on the side close to the light emitting surface 12 so that part of light beams from the emitting element 20 can directly reach the light incident surface.

The reflector element 30 surrounds the transparent element 10 and the emitting element 20 and doesn't block the light emitting surface 12. The reflector element 30 may be an element having a surface of a reflection layer or a mirror-side reflector such as a mirror or an aluminum plate. It is utilized to reflect the part of light beams that don't directly enter into the transparent element 10 one or more times until they enter into the transparent element 10.

The shape of the transparent element 10 can be decided according to its application. As shown in FIG. 2, the transparent element 10 has a tunnel shape. The reflector element 30 is arranged on two sides of the long axis of the transparent element 10. The two emitting elements 20 are symmetrically arranged on two ends of the long axis of the transparent element 10. If the number of the emitting elements 20 is increased, the added emitting elements 20 also need to be arranged symmetrically. By arranged like that, one part of the light beams from the emitting elements 20 can directly enter the transparent element 10 from the two ends of the long axis of the transparent element 10, and another part of the light beams also can enter into the transparent element 10 after being reflected one or more times by the reflector element 30. Thus, the transparent element 10 can display with uniform light beams and the light indicator has a good indicating effect.

FIG. 3 is a schematic diagram showing a light indicator according to another embodiment of the invention. As shown in FIG. 3, the reflector element 30 also surrounds the sides back to the transparent element 10 of the two emitting elements 20. So the light beams emitted from the back sides of the emitting elements 20 also can enter into the transparent element 10 after being reflected one or more times by the reflector element 30. Therefore, light leakage and light waste can be avoided and the light indicator has a good light utilization rate.

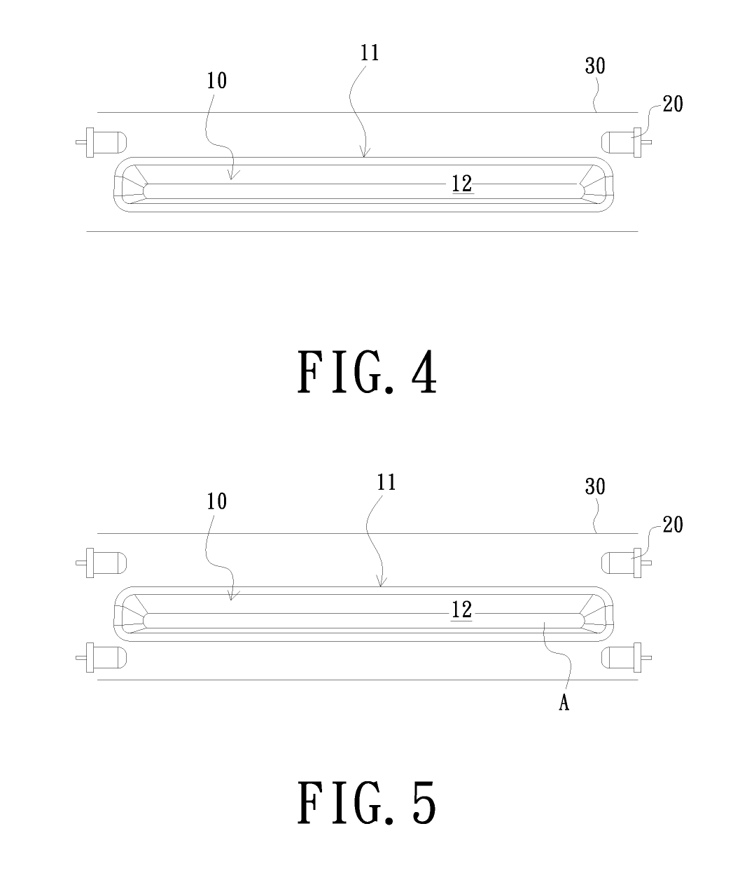

FIG. 4 is a schematic diagram showing an application of a light indicator of the invention. As shown in FIG. 4, the transparent element 10 is utilized as a disc entry or an object entry. It includes four borders connecting one by another. The two emitting elements 20 are two LEDs. The two emitting elements are arranged on the long axis of the transparent element 10. By arranged like that, one part of the light beams from the emitting elements 20 can directly enter the transparent element 10 from the two ends of the long axis of the transparent element 10, and another part of the light beams also can enter into the transparent element 10 after being reflected one or more times by the reflector element 30. Thus, the transparent element 10 can display with uniform light beams and the light indicator has a good indicating effect. In addition, as shown in FIG. 5, several emitting element 20 may be added to keep them symmetrically arranged.

According to another preferred embodiment of the invention, some light-scattering impurities such as silver powder can be mixed into the transparent element 10 to enhance the scattering effect of the light beams in the transparent 10. Thus, the transparent element 10 can display with uniform light beams.

The above description is given by way of example, and not limitation. Given the above disclosure body, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A light indicator, comprising:
a transparent element comprising a light incident surface and a light emitting surface for light beams emitting out;
an emitting element arranged symmetrically on two sides of the transparent element to make that light beams emitted from the emitting element can enter into the transparent element though the light incident surface and the light emitting surface can emit uniform light beams; and a reflector element surrounding the transparent element and the emitting element and not blocking the light emitting surface to ensure that part of light beams can enter into the transparent element through the light incident surface after being reflected one or more times.

2. The light indicator of claim 1, wherein the transparent element is made of polymethyl methacrylate (PMMA).

3. The light indicator of claim 1, wherein the transparent element is made of Polyvinylchloride (PVC).

4. The light indicator of claim 1, wherein the transparent element is made of polycarbonate (PC).

5. The light indicator of claim 1, wherein the incident surface is a frosting surface.

6. The light indicator of claim 1, wherein the incident surface is a rough surface.

7. The light indicator of claim 1, wherein the transparent element is mixed into light-scattering impurity.

8. The light indicator of claim 7, wherein the light-scattering impurity is silver powder.

9. The light indicator of claim 1, wherein the number of the emitting elements is at least two.

10. The light indicator of claim 9, wherein the transparent element is of a tunnel shape, the reflector element is substantially arranged at the two sides of the long axis of the transparent element, and the emitting elements are symmetrically arranged at the two ends of the long axis of the transparent element.

11. The light indicator of claim 1, wherein the emitting element is a light emitting diode (LED).

12. The light indicator of claim 1, wherein the emitting element is a bulb.

13. The light indicator of claim 1, wherein the emitting element is a cold cathode fluorescent lamp (CCFL).

14. The light indicator of claim 1, wherein the reflector element is a mirror or an aluminum plate.

15. The light indicator of claim 1, wherein the reflector further surrounds the side back to the transparent element of the emitting element.
